(19) United States
(12) Patent Application Publication
(10) Pub. No.: US 2026/0028431 A1
(43) Pub. Date: Jan. 29, 2026

(54) Method and processing facility for processing styrene acrylonitrile

(71) Applicant: Coperion GmbH, Stuttgart (DE)

(72) Inventors: Frank LECHNER, Ludwigsburg (DE); Oliver BEISER, Stuttgart (DE)

(21) Appl. No.: 19/277,783

(22) Filed: Jul. 23, 2025

(30) Foreign Application Priority Data
Jul. 23, 2024 (EP) 24 190 324.4

(51) Int. Cl. C08C 4/00

(52) U.S. Cl. CPC C08C 4/00

(57) ABSTRACT

A processing facility (1) comprises a processing screw machine (4) for processing dewatered rubber (7) and styrene acrylonitrile, a dewatering screw machine (2) for dewatering wet rubber (6) and providing the dewatered rubber (7), and a feed device (3) for feeding the dewatered rubber (7) into the processing screw machine (4). Because the dewatering and the processing are mechanically decoupled, simple, flexible and efficient processing can be achieved.

### PRIORITY CLAIM

The present application claims the priority of European patent application No. 24 190 324.4, the contents of which are incorporated here in their entirety by reference.

### TECHNICAL FIELD

The invention relates to a method and processing facility for processing styrene acrylonitrile.

### BACKGROUND

WO 2022/229 347 A1 discloses a method and processing facility for processing styrene acrylonitrile (SAN). The processing facility comprises an extruder which forms in succession, in a conveying direction, a first intake zone, a preheating zone, a mechanical dewatering zone, a second intake zone, a first degassing zone, a third intake zone, a second degassing zone and a discharge zone. In the first intake zone, acrylonitrile butadiene styrene (ABS) and optionally additives are fed into the extruder, heated in the preheating zone, and subsequently dewatered in the dewatering zone. In the second intake zone, styrene acrylonitrile is fed into the extruder. The mixture subsequently produced in the extruder is degassed in the degassing zones. In the third intake zone, styrene acrylonitrile and additives can again be fed into the extruder. The degassed mixture is discharged from the extruder in the discharge zone.

It would be helpful to provide a method which makes simple, flexible, and efficient processing of styrene acrylonitrile possible.

### SUMMARY

According to one aspect of the disclosure, the dewatering of the rubber, in particular the acrylonitrile butadiene styrene (ABS), and the processing of the styrene acrylonitrile (SAN) are mutually mechanically decoupled. The processing facility comprises a dewatering screw machine and at least one separate processing screw machine. The dewatering screw machine is for dewatering wet rubber, whereas the at least one processing screw machine is for producing a mixture of the dewatered rubber and styrene acrylonitrile and degassing the resulting mixture. Because the method steps of dewatering and processing, in other words producing the mixture and degassing the resulting mixture, are mechanically divided between the dewatering screw machine and the at least one processing screw machine, these method steps can be carried out simply, flexibly and efficiently. In particular, the dewatering screw machine can be optimally configured and operated for the dewatering method step, whereas the at least one processing screw machine can be configured and operated for the processing method step.

Natural rubber and/or synthetic rubber may be used. Acrylonitrile butadiene styrene (ABS), for example, may be used as a synthetic rubber.

The dewatering screw machine comprises at least one dewatering shaft, or possibly at least two dewatering shafts. During operation of the dewatering screw machine, the at least one dewatering shaft rotates at a rotational speed n_{E}. In particular, for the rotational speed n_{E}: 40 rpm≤n_{E}≤600 rpm, in particular 50 rpm≤n_{E}≤400 rpm and in particular 60 rpm≤n_{E}≤300 rpm.

The dewatering screw machine may be configured as a single-shaft dewatering screw machine or as a multi-shaft dewatering screw machine. The dewatering screw machine can be configured as a co-rotating or counter-rotating twin-shaft dewatering screw machine comprising two dewatering shafts. The dewatering shafts may be drivable in rotation or driven in rotation in the same or opposite directions.

The wet rubber has the first water content W₁ when fed into the dewatering screw machine, whereas the dewatered rubber has the second water content W₂when discharged from the dewatering screw machine. In particular, for a relative water content change ΔW=(W₁−W₂)/W₁: 50%≤ΔW≤99%, in particular 60%≤ΔW≤95% and in particular 70%≤ΔW≤90%.

After being discharged from the dewatering screw machine, the dewatered rubber may be fed into the at least one processing screw machine. The dewatered rubber may be fed to one processing screw machine or to a plurality of processing screw machines. A plurality of processing screw machines are arranged mutually parallel, in such a way that the dewatered rubber can be distributed among the plurality of processing screw machines. The processing facility comprises a first feed device for feeding the dewatered rubber into the at least one processing screw machine.

The at least one processing screw machine, in particular each processing screw machine, is possibly configured as a multi-shaft processing screw machine. Each of the at least one processing screw machines has in particular at least two treatment element shafts. The at least two treatment element shafts are in particular drivable in rotation or driven in rotation in the same direction. Possibly, the at least one processing screw machine, in particular each processing screw machine, is configured as a co-rotating twin-shaft processing screw machine. Each processing screw machine thus comprises exactly two treatment element shafts, drivable in rotation or driven in rotation in the same direction.

The at least two treatment element shafts have a rotational speed n_{A} during operation. In particular, for each rotational speed n_{A}: 40 rpm≤n_{A}≤1200 rpm, in particular 100 rpm≤n_{A}≤1000 rpm and in particular 200 rpm≤n_{A}≤800 rpm.

The styrene acrylonitrile may be fed into the at least one processing screw machine as bulk material and/or as a melt. Possibly, at least one additive is fed into the at least one processing screw machine and mixed with the dewatered rubber and styrene acrylonitrile to form the mixture.

For feeding the styrene acrylonitrile into the at least one processing screw conveyor, the processing facility may comprise an associated second feed device. The associated second feed device may in particular comprise a metering device and/or a feed screw conveyor.

A method ensures simple, flexible and efficient processing of styrene acrylonitrile. Because the dewatering screw machine is optimised for the dewatering method step, the wet rubber can be dewatered down to a desired second water content W₂, even for a high first water content W₁.

A method ensures simple, flexible and efficient processing of styrene acrylonitrile. Because the dewatering screw machine is optimised for the dewatering method step, a low second water content W₂ of the dewatered rubber can be achieved. Preferably, the second water content W₂ is at most 12% by weight, in particular at most 6% by weight, in particular at most 5% by weight and in particular at most 2% by weight. The lower the second water content W₂, the easier it is to degas the produced mixture using the at least one processing screw machine.

A method ensures simple, flexible and efficient processing of styrene acrylonitrile. By way of the temperature T_{K}, the thermal energy of the dewatered rubber is used for processing the styrene acrylonitrile. The thermal energy positively influences the viscosity of the styrene acrylonitrile, resulting in improved mixing and homogenisation of the styrene acrylonitrile with the dewatered rubber. If the styrene acrylonitrile is fed as a bulk material, for example as a powder and/or a granulate, the styrene acrylonitrile can be plasticised more easily and quickly in the at least one processing screw machine using the thermal energy. If the styrene acrylonitrile is fed as a melt, the viscosity of the styrene acrylonitrile melt is at least not impaired. The temperature T_{K} thus ensures simple and efficient mixing and homogenisation of the dewatered rubber and styrene acrylonitrile.

A method ensures simple, flexible and efficient processing of styrene acrylonitrile. By feeding the dewatered rubber into the at least one processing screw machine upstream from the styrene acrylonitrile feed, improved homogenisation of the dewatered rubber and styrene acrylonitrile is achieved. If the styrene acrylonitrile is fed as a bulk material, for example as a powder and/or a granulate, the styrene acrylonitrile and the dewatered rubber are plasticised or masticated together in the at least one processing screw machine and homogenised in a simple and efficient manner. If the styrene acrylonitrile is fed as a melt, the dewatered rubber is masticated in the styrene acrylonitrile melt and simultaneously homogenised.

A method ensures simple, flexible and efficient processing of styrene acrylonitrile. By feeding the styrene acrylonitrile as a bulk material, for example as a powder and/or a granulate, the styrene acrylonitrile and the dewatered rubber are plasticised or masticated together in the at least one processing screw machine and thereby homogenised. If the styrene acrylonitrile is fed as a melt, the dewatered rubber is masticated directly in the styrene acrylonitrile melt and simultaneously homogenised. This improves the processing of the styrene acrylonitrile.

A method ensures simple, flexible and efficient processing of styrene acrylonitrile. Each seal is in particular a melt seal. Each seal in the at least one processing screw machine prevents moisture from escaping from the mixture during processing and prevents generated water vapour from flowing back counter to the conveying direction in the at least one processing screw machine. Preventing backflow in turn prevents the feed of the dewatered rubber or styrene acrylonitrile from being impaired. Preferably, the first feed point for the dewatered rubber is arranged upstream from the second feed point for the styrene acrylonitrile in the conveying direction. The styrene acrylonitrile is fed into the at least one processing screw machine as a melt and/or as a bulk material. The bulk material is plasticised into a melt in the at least one processing screw machine. Because of the temperature of the styrene acrylonitrile melt, any residual moisture contained in the dewatered rubber comes out as steam. Each seal prevents this steam from flowing back counter to the conveying direction in the at least one processing screw machine and in particular from impairing the feed of the dewatered rubber.

It is possible to create a processing facility which enables simple, flexible and efficient processing of styrene acrylonitrile.

This is possibly achieved by a processing facility corresponding to the previously described methods. In particular, the methods may be developed with at least one feature described in connection with the processing facility.

Because the processing facility may comprise a dewatering screw machine and at least one processing screw machine, the dewatering of the wet rubber and the processing of the dewatered rubber and the styrene acrylonitrile are mutually mechanically decoupled or separated. The dewatering screw machine may be configured to dewater the wet rubber, whereas the at least one processing screw machine, in particular each processing screw machine, may be configured to process the dewatered rubber and styrene acrylonitrile. This improves the processing of styrene acrylonitrile. In particular, simple, flexible and efficient processing is achieved.

The dewatering screw machine can comprise a housing and at least one dewatering shaft arranged in an associated housing bore of the housing. The at least one dewatering shaft is in particular configured double-flighted. The dewatering screw machine possibly comprises at least two dewatering shafts, possibly exactly two dewatering shafts, arranged in associated housing bores of the housing. The two housing bores penetrate one another and have a horizontal figure-of-eight shape in cross section.

The dewatering screw machine is possibly configured as a co-rotating or counter-rotating multi-shaft dewatering screw machine.

Each processing screw machine possibly comprises a housing and at least two treatment element shafts arranged in associated housing bores of the housing. The at least two treatment element shafts are in particular double-flighted. Each processing screw machine possibly comprises exactly two treatment element shafts arranged in associated housing bores of the housing. The two housing bores penetrate one another and have a horizontal figure-of-eight shape in cross section. Each processing screw machine is possibly configured as a co-rotating multi-shaft processing screw machine, in particular a twin-shaft processing screw machine.

The at least one processing screw machine, in particular each processing screw machine, comprises at least one feed opening for feeding the dewatered rubber and styrene acrylonitrile. Possibly, each of the at least one processing screw machines comprises a first feed opening for feeding the dewatered rubber and a second feed opening for feeding the styrene acrylonitrile. Possibly, the first feed opening is arranged upstream from the second feed opening in a conveying direction of the associated processing screw machine.

The feed device is for feeding the dewatered rubber into the at least one processing screw machine. For this purpose, the dewatering screw machine opens into the feed device, in such a way that the dewatered rubber is provided to the feed device. The feed device in turn opens into the at least one processing screw machine, in particular into the first feed opening of the associated processing screw machine.

The processing facility possibly comprises a first feed device for feeding the dewatered rubber into the at least one processing screw machine and at least one second feed device for feeding the styrene acrylonitrile into the at least one processing screw machine. If the processing facility has a plurality of processing screw machines, the styrene acrylonitrile can be fed into the processing screw machines by means of a shared second feed device or by means of respective second feed devices. Possibly, the first feed device opens into the first feed opening in each case, and the at least one second feed device opens into at least one associated second feed opening.

A processing facility can ensure simple, flexible and efficient processing of styrene acrylonitrile. By way of the ratio L_{E}/D_{E}. the dewatering screw machine ensures simple and efficient dewatering of the wet rubber. The greater the ratio L_{E}/D_{E}, the greater the length of at least one dewatering zone of the dewatering screw machine. This makes it possible to set the desired degree of dewatering of the wet rubber.

A processing facility can ensure simple, flexible and efficient processing of styrene acrylonitrile. The at least one dewatering shaft is arranged in an associated housing bore of a housing of the dewatering screw machine. The ratio D_{E}/d_{E} can be used to set a free volume or a free cross-sectional area within the at least one housing bore, making it possible to adjust kneading of the wet rubber and squeezing of water from the wet rubber. Furthermore, the ratio D_{E}/d_{E} can be used to limit the mechanical energy input into the wet rubber. The ratio D_{E}/d_{E} preferably applies to at least one dewatering zone, in particular to each dewatering zone formed in the dewatering screw machine.

A processing facility can ensure simple, flexible and efficient processing of styrene acrylonitrile. The dewatering screw machine preferably comprises a plurality of dewatering zones arranged in succession in a conveying direction. The dewatering screw machine preferably comprises a housing and at least one dewatering shaft arranged in an associated housing bore of the housing. Each dewatering shaft preferably comprises at least one kneading element and/or at least one retention element in each dewatering zone. Each dewatering shaft preferably comprises at least one kneading element and at least one retention element, arranged downstream from the at least one kneading element in a conveying direction, in each dewatering zone. The at least one retention element ensures that the wet rubber remains in the region of the at least one kneading element for a desired residence time and is thus intensively mixed and kneaded by the at least one kneading element. This results in water being squeezed out of the wet rubber. Each dewatering zone is preferably assigned at least one dewatering opening formed in the housing. At least one dewatering opening is preferably arranged upstream from the at least one retention element of the dewatering zone. To drain the squeezed-out water, a filter insert and/or a drainage screw conveyor may be connected to the associated dewatering opening. Each drainage screw conveyor may be configured for example as a twin-shaft drainage screw conveyor. Each twin-shaft drainage screw conveyor may be configured co-rotating or counter-rotating.

A processing facility can ensure simple, flexible and efficient processing of styrene acrylonitrile. The feed device makes it possible to feed the dewatered rubber directly from the dewatering screw machine into the at least one processing screw machine. For this purpose, a discharge opening of the dewatering screw machine is connected by means of the feed device to an associated feed opening of the at least one processing screw machine. The dewatering screw machine may be directly connected to the at least one processing screw machine, for example by means of at least one feed pipeline and/or by means of at least one feed hopper. A buffer tank may be provided for temporarily storing or buffering the dewatered rubber immediately before it is fed into the at least one processing screw machine. The dewatered rubber may be fed into the at least one processing screw machine with metering by means of an associated metering device and/or an associated feed screw machine.

A processing facility can ensure simple, flexible and efficient processing of styrene acrylonitrile. The ratio L_{A}/D_{A} makes a desired homogenisation of the dewatered rubber and styrene acrylonitrile possible, as well as effective degassing of the resulting mixture. The smaller the ratio L_{A}/D_{A}, the lower the mechanical complexity.

A processing facility can ensure simple, flexible and efficient processing of styrene acrylonitrile. The associated processing screw machine comprises a housing and at least two treatment element shafts arranged in associated housing bores of the housing. A free volume or a free cross-sectional area in the at least two housing bores can be set using the ratio D_{A}/d_{A}. Intensive mixing and homogenisation of the dewatered rubber and styrene acrylonitrile can be achieved using the free volume or the free cross-sectional area. In addition, the free volume or the free cross-sectional area can be used to limit the mechanical energy input and the shear forces which occur. The greater the ratio D_{A}/d_{A}, the greater the free volume or free cross-sectional area.

A processing facility can ensure simple, flexible and efficient processing of styrene acrylonitrile. Because the dewatered rubber is fed into each processing screw machine at a first feed point, which is arranged upstream from a second feed point of the styrene acrylonitrile in the conveying direction, the dewatered rubber can be processed directly with the styrene acrylonitrile. If the styrene acrylonitrile is fed into the associated processing screw machine as a bulk material, for example as a powder and/or a granulate, the dewatered rubber and styrene acrylonitrile bulk material can be plasticised or masticated and homogenised together. If the styrene acrylonitrile is fed into the associated processing screw machine as a melt, the dewatered rubber can be fed directly into the styrene acrylonitrile melt. The dewatered rubber is melted directly in the styrene acrylonitrile melt and homogenised with it.

A processing facility can ensure simple, flexible and efficient processing of styrene acrylonitrile. The retention zone between the first feed opening for feeding the dewatered rubber and the second feed opening for feeding the styrene acrylonitrile prevents moisture from escaping during the processing of the dewatered rubber and styrene acrylonitrile and prevents generated water vapour from flowing back counter to the conveying direction in the associated processing screw machine and impairing the feeding of the dewatered rubber. Each processing screw machine comprises at least two treatment element shafts. Each processing screw machine has at least one retention element in the retention zone for each treatment element shaft. The at least one retention element has a conveying direction directed counter to the conveying direction of the associated processing screw machine. The at least one retention element per treatment element shaft creates a seal in the retention zone which prevents the escaped moisture or the resulting water vapour from flowing back. The associated seal is in particular a melt seal.

A processing facility can ensure simple, flexible and efficient processing of styrene acrylonitrile. Before the styrene acrylonitrile is fed, the dewatered rubber is degassed again by the at least one first degassing zone, which is arranged upstream from the second feed opening in the conveying direction. The residual second water content W₂ of the dewatered rubber is reduced again in the at least one first degassing zone. For this purpose, at least one kneading element is arranged in the at least one first degassing zone, and intensively mixes the dewatered rubber in such a way that the residual second water content W₂ can escape at least in part in the form of water vapour. The at least one first degassing zone is assigned at least one degassing opening, formed in a housing of the associated processing screw machine. The water vapour can escape from the housing through the at least one degassing opening. An associated first degassing device may be connected to the at least one degassing opening. Preferably, the associated processing screw machine has at least two first degassing zones arranged in succession and upstream from the second feed opening in the conveying direction. A retention zone for forming a seal, in particular a melt seal, may be formed between first degassing zones arranged directly in succession.

A processing facility can ensure simple, flexible and efficient processing of styrene acrylonitrile. Downstream from the second feed opening, a mixture in the form of a melt is produced from the dewatered rubber and styrene acrylonitrile. In the at least one second degassing zone, this melt is intensively mixed and homogenised, in such a way that residual water and/or other volatile components can escape from this melt. Each processing screw machine comprises at least two treatment element shafts. In the at least one second degassing zone, at least one kneading element per treatment element shaft is arranged. The at least one second degassing zone is assigned at least one second degassing opening, formed in the housing of the associated processing screw machine. The residual water or the residual water vapour and/or the other volatile components can escape through the at least one second degassing opening. Each of the at least one second degassing openings may be connected to an associated second degassing device. Preferably, at least two second degassing zones are arranged downstream from the second feed opening, preferably between two and four second degassing zones arranged in succession. Between directly consecutive second degassing zones, in each case a retention zone may be formed to form a seal, in particular a melt seal. Preferably, each second degassing zone is assigned a second degassing opening. The second degassing devices may in particular comprise a twin-shaft side-degassing screw machine.

### DESCRIPTION OF THE DRAWINGS

FIG. 1 is a partially sectional plan view of a processing facility for processing styrene acrylonitrile according to a first embodiment with a dewatering screw machine, a feeding device and a processing screw machine,

FIG. 2 is a sectional view through the processing facility of FIG. 1 along the section line II-II,

FIG. 3 is a sectional view through the processing facility of FIG. 1 along the section line III-III,

FIG. 4 is a sectional view corresponding to FIG. 2 through a processing facility for processing styrene acrylonitrile according to a second embodiment, and

FIG. 5 is a sectional view corresponding to FIG. 3 through the processing facility according to the second embodiment.

### DETAILED DESCRIPTION

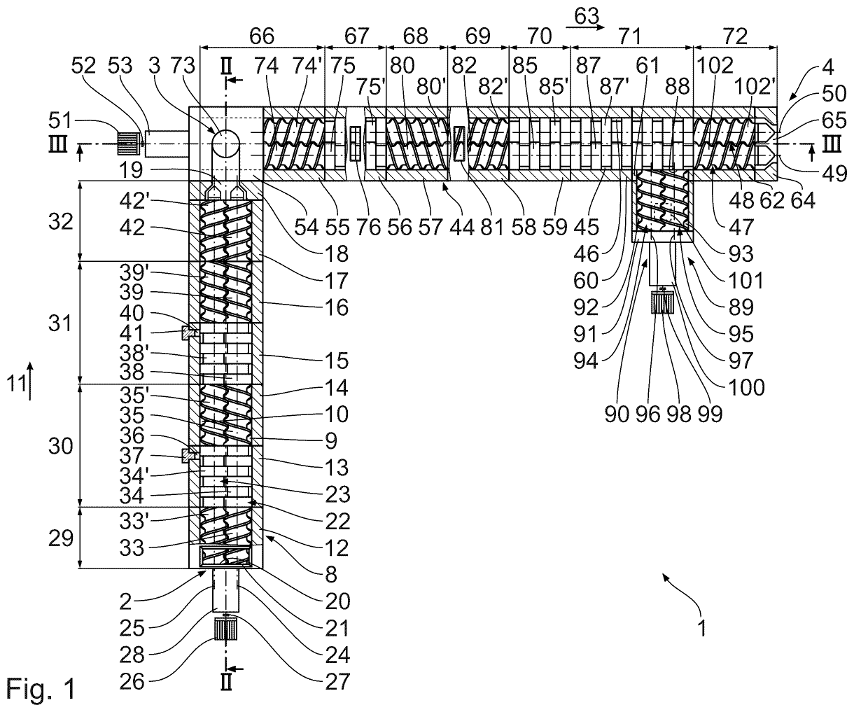

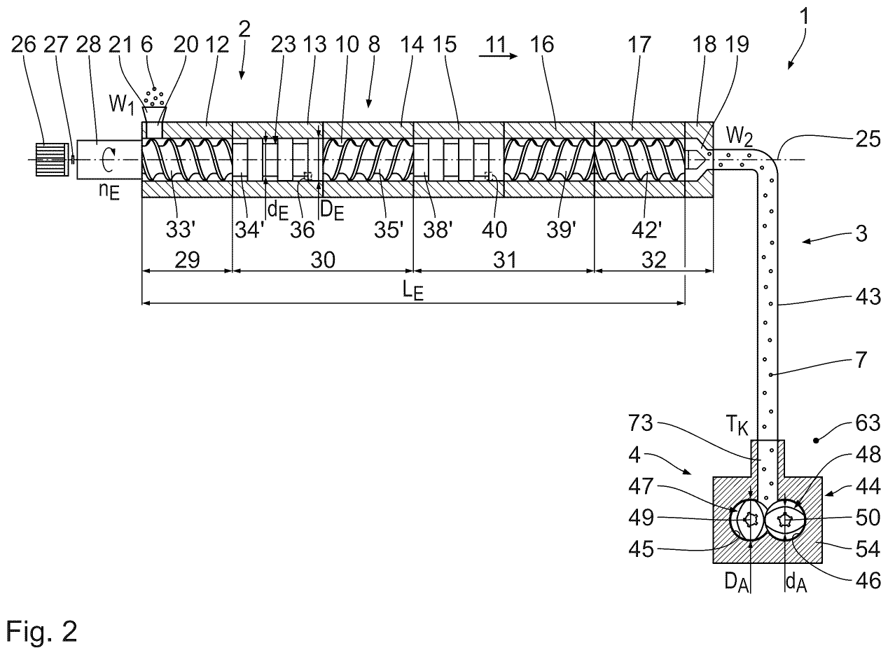

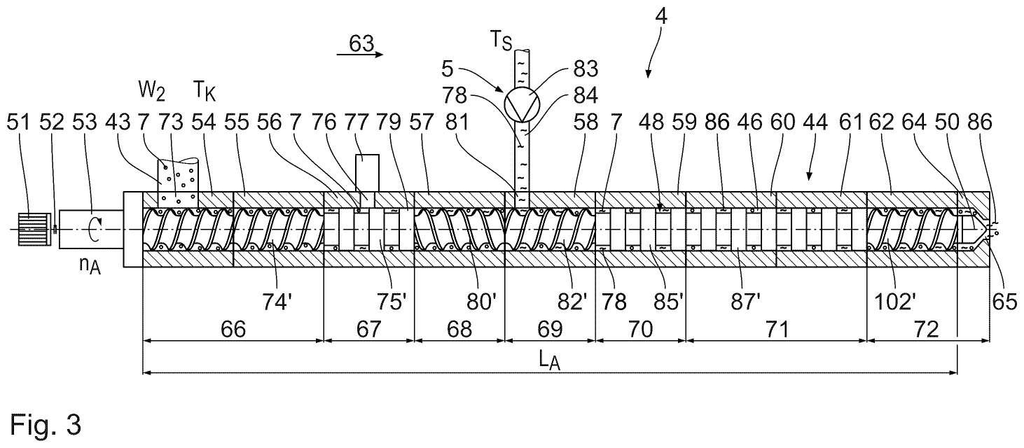

A first embodiment of the invention is described in the following with reference to FIGS. 1 to 3. The processing facility 1 shown in FIGS. 1 to 3 is for continuously processing styrene acrylonitrile (SAN). For processing the styrene acrylonitrile, the processing facility 1 comprises a dewatering screw machine 2, a first feed device 3, a processing screw machine 4 and a second feed device 5.

The dewatering screw machine 2 is for dewatering wet rubber 6 and providing dewatered rubber 7. The dewatering screw machine 2 is configured as a co-rotating multi-shaft dewatering screw machine or as a co-rotating twin-shaft dewatering screw machine. The dewatering screw machine 2 comprises a housing 8 in which two mutually parallel and interpenetrating housing bores 9, 10 are formed. The housing bores 9, 10 have a horizontal figure-of-eight shape in cross section.

The housing 8 comprises a plurality of housing portions 12 to 17, arranged in succession in a first conveying direction 11 and interconnected to form the housing 8. The housing 8 further comprises a discharge plate 18, which closes the housing 8 at the last housing portion 17. The discharge plate 18 is connected to the last housing portion 17. For discharging the dewatered rubber 7, the discharge plate 18 comprises a discharge opening 19.

For feeding the wet rubber 6 into the dewatering screw machine 2, a feed opening 20 is formed in the first housing portion 12. For feeding, the dewatering screw machine 2 comprises a feed hopper 21, which opens into the feed opening 20.

Two dewatering shafts 22, 23 are arranged in the housing bores 9, 10 and can be driven in rotation about associated axes of rotation 24, 25 in the same direction of rotation. For rotational drive, the dewatering screw machine 2 comprises an electric drive motor 26 and a branching gear 28, between which a coupling 27 is arranged. The dewatering shafts 22, 23 are driven in rotation about the axes of rotation 24, 25 in the same direction of rotation by the drive motor 26 via the branching gear 28.

The dewatering screw machine 2 forms in succession, in the first conveying direction 11, an intake zone 29, a first dewatering zone 30, a second dewatering zone 31 and a discharge zone 32. In the intake zone 29, the feed opening 20 is formed in the housing portion 12. The wet rubber 6 is fed by way of the feed hopper 21. In the intake zone 29, the dewatering shafts 22, 23 have conveying elements 33, 33′ or screw elements.

Alternatively, the wet rubber 6 may be fed into the feed opening 21 by means of a vertically or horizontally arranged stuffing screw. In the case of a horizontal stuffing screw, the feed opening 20 is formed laterally in the housing portion 12.

In the intake zone 29, the wet rubber 6 is conveyed in the first conveying direction 11 to the first dewatering zone 30. In the first dewatering zone 30, the wet rubber 6 is dewatered. For this purpose, the dewatering shafts 22, 23 have kneading elements 34, 34′ and retention elements 35, 35′ arranged in succession in the first conveying direction 11. The kneading elements 34, 34′ comprise in particular kneading blocks, with integrally interconnected kneading discs, and/or individual kneading discs. The retention elements 35, 35′ are configured as screw elements whose conveying direction is counter to the first conveying direction 11. The pitch of the retention elements 35, 35′ can be used to adjust the retention effect and thus the residence time of the wet rubber 6 in the first dewatering zone 30.

In the first dewatering zone 30, a first dewatering opening 36 is formed in the housing 8. Squeezed-out water in the first dewatering zone 30 can flow out of the housing 8 through the first dewatering opening 36. The first dewatering opening 36 is arranged for example in the region of the kneading elements 34, 34′. The dewatering screw machine 2 comprises a first filter insert 37 arranged in the first dewatering opening 36. The first filter insert 37 holds back the wet rubber 6, but allows the water to flow off. As an alternative to the first filter insert 37, a drainage screw machine may be connected to the first dewatering opening 36. The drainage screw machine may be configured for example as a co-rotating or counter-rotating twin-shaft drainage screw machine. The drainage screw machine may be connected laterally.

As a result of the conveying action of the conveying elements 33, 33′, the wet rubber 6 is pressed through the first dewatering zone 30 into the second dewatering zone 31. In the second dewatering zone 31, further dewatering of the wet rubber 6 takes place. In the second dewatering zone 31, the dewatering shafts 22, 23 have kneading elements 38, 38′ and retention elements 39, 39′, in succession in the first conveying direction 11. The kneading elements 38, 38′ comprise in particular kneading blocks, with integrally interconnected kneading discs, and/or individual kneading discs. The retention elements 39, 39′ are configured as screw elements whose conveying direction is counter to the first conveying direction 11. The pitch of the retention elements 39, 39′ can be used to adjust the retention effect and thus the residence time of the wet rubber 6 in the second dewatering zone 31.

To drain the squeezed-out water, a second dewatering opening 40 is formed in the housing 8 in the second dewatering zone 31. The second dewatering opening 40 is arranged in the region of the kneading elements 38, 38′. The dewatering screw machine 2 comprises a second filter insert 41 arranged in the second dewatering opening 40. The second filter insert 41 holds back the wet rubber 6, but allows the squeezed-out water to be drained. As an alternative to the second filter insert 41, a drainage screw machine may be connected to the second dewatering opening 40. The drainage screw machine may be configured for example as a co-rotating or counter-rotating twin-shaft drainage screw machine. The drainage screw machine may be connected laterally.

By dewatering the wet rubber 6 in the dewatering zones 30, 31, the dewatered rubber 7 is provided in the discharge zone 32. In the discharge zone 32, the dewatering shafts 22, 23 have conveying elements 42, 42′ or screw elements.

The dewatering shafts 22, 23 are configured double-flighted. The dewatering shafts 22, 23 have a length L_{E} in the first conveying direction 11. Furthermore, the dewatering shafts 22, 23 have an external diameter D_{E} and an internal diameter d_{E}.

For the ratio of the length L_{E} to the external diameter D_{E}: 16≤L_{E}/D_{E}≤40, in particular 18≤L_{E}/D_{E}≤34 and in particular 20≤L_{E}/D_{E}≤28.

For the ratio of the external diameter D_{E} to the internal diameter d_{E}: 1.22≤D_{E}/d_{E}≤1.8, in particular 1.4≤D_{E}/d_{E}≤1.66 and in particular 1.5≤D_{E}/d_{E}≤1.6.

The first feed device 3 is for feeding the dewatered rubber 7 into the processing screw machine 4. The first feed device 3 comprises a feed pipeline 43. The feed pipeline 43 connects the dewatering screw machine 2 to the processing screw machine 4. For this purpose, the feed pipeline 43 is connected to the discharge opening 19.

The processing screw machine 4 is configured as a co-rotating multi-shaft processing screw machine or as a co-rotating twin-shaft processing screw machine. The processing screw machine 4 comprises a housing 44 in which two mutually parallel and interpenetrating housing bores 45, 46 are formed. The housing bores 45, 46 have a horizontal figure-of-eight shape in cross section. Two treatment element shafts 47, 48 are arranged in the housing bores 45, 46, and can be driven in rotation about associated axes of rotation 49, 50 in the same direction of rotation. For rotational drive, the processing screw machine 4 comprises an electric drive motor 51 and a branching gear 53, between which a coupling 52 is arranged. The treatment element shafts 47, 48 are driven in rotation about the axes of rotation 49, 50 in the same direction of rotation by means of the drive motor 51 via the branching gear 53.

The housing 44 comprises a plurality of housing portions 54 to 62, arranged in succession in a second conveying direction 63 and interconnected to form the housing 44. The housing 44 comprises a discharge plate 64, which is connected to the last housing portion 62 and closes the housing 44. The discharge plate 64 comprises a discharge opening 65.

The processing screw machine 4 forms in succession, in the second conveying direction 63, a first intake zone 66, a first degassing zone 67, a retention zone 68, a second intake zone 69, a melting zone 70, a second degassing zone 71 and a discharge zone 72.

In the first intake zone 66, the housing 44 has a first feed opening 73. The first feed opening 73 is for feeding the dewatered rubber 7. For this purpose, the feed pipeline 43 opens into the first feed opening 73. In the first intake zone 66, the fed dewatered rubber 7 is conveyed in the second conveying direction 63 to the first degassing zone 67. For this purpose, the treatment element shafts 47, 48 in the first intake zone 66 have conveying elements 74, 74′ or screw elements.

The first degassing zone 67 is for reducing the water remaining in the dewatered rubber 7. For this purpose, the treatment element shafts 47, 48 in the first degassing zone 67 comprise kneading elements 75, 75′. The kneading elements 75, 75′ comprise in particular kneading blocks, with integrally interconnected kneading discs, and/or individual kneading discs. As a result of the intensive kneading of the dewatered rubber 7, water vapour comes out. For the water vapour to escape, the housing 44 comprises a first degassing opening 76 in the first degassing zone 67. The processing facility 1 comprises a first degassing device 77, which is connected to the first degassing opening 76. The first degassing device 77 is configured for example as a vacuum degassing dome.

The styrene acrylonitrile is fed to the processing screw machine 4 in the second intake zone 69 as a styrene acrylonitrile melt 78 (SAN melt). The retention zone 68, arranged upstream in the second conveying direction 63, is for forming a melt seal 79 using the SAN melt 78. For this purpose, the treatment element shafts 47, 48 in the retention zone 68 comprise retention elements 80, 80′. The retention elements 80, 80′ are configured as screw elements whose conveying direction is counter to the second conveying direction 63. The retention elements 80, 80′ can also be used to adjust the residence time of the dewatered rubber 7 in the first degassing zone 67.

In the second intake zone 69, the housing 44 has a second feed opening 81. The second feed opening 81 is for feeding the SAN melt 78. The first feed opening 73, the first degassing zone 67 and the retention zone 68 are thus arranged upstream from the second feed opening 81 in the second conveying direction 63. The dewatered rubber 7 is thus fed upstream from the SAN melt 78 in the second conveying direction 63. In the second intake zone 69, the treatment element shafts 47, 48 comprise conveying elements 82, 82′ or screw elements. The conveying elements 82, 82′ are for conveying the dewatered rubber 7 and the SAN melt 78 into the melting zone 70.

The second feed device 5 is for feeding the SAN melt 78. The second feed device 5 comprises a melt pump 83 and a feed pipeline 84. The feed pipeline 84 opens into the second feed opening 81. The melt pump 83 is for conveying the SAN melt 78 through the feed pipeline 74 into the second feed opening 81. The SAN melt 78 is provided for example by a production plant.

In the melting zone 70, the dewatered rubber 7 is masticated in the SAN melt 78 and homogenised with it. For this purpose, the treatment element shafts 47, 48 in the melting zone 70 comprise kneading elements 85, 85′. The kneading elements 85, 85′ comprise in particular kneading blocks, with integrally interconnected kneading discs, and/or individual kneading discs.

A molten mixture 86 is produced from the dewatered rubber 7 and the SAN melt 78 in the melting zone 70, and is conveyed into the second degassing zone 71. The second degassing zone 71 is arranged downstream from the second feed opening 81 in the second conveying direction 63. The molten mixture 86 is kneaded and homogenised in the second degassing zone 71. As a result, water vapour and/or other volatile components come out of the molten mixture 86. For kneading and homogenisation, the treatment element shafts 47, 48 in the second degassing zone 71 comprise kneading elements 87, 87′. The kneading elements 87, 87′ comprise in particular kneading blocks, with integrally interconnected kneading discs, and/or individual kneading discs. To drain the water vapour and/or the other volatile components, the housing 44 comprises a second degassing opening 88 in the second degassing zone 71. The second degassing opening 88 is formed laterally in the housing 44 or in the housing portion 61.

The processing facility 1 comprises a second degassing device 89 for draining the water vapour and/or the other volatile components from the second degassing zone 71. The second degassing device 89 comprises a twin-shaft degassing screw machine 90. The degassing screw machine 90 comprises a housing 91 in which two mutually parallel and interpenetrating housing bores 92, 93 are formed. The housing bores 92, 93 have a horizontal figure-of-eight shape in cross section. Two screw shafts 94, 95 are arranged in the housing bores 92, 93 and can be driven in rotation about associated axes of rotation 96, 97 in the same direction of rotation. For rotational drive, the degassing screw machine 90 comprises an electric drive motor 98 and a branching gear 100, between which a clutch 99 is arranged. The screw shafts 94, 95 are driven in rotation in the same direction about the axes of rotation 96, 97 by the drive motor 98 via the branching gear 100. The housing 91 comprises a drainage opening 101 for draining the water vapour and/or the other volatile components from the degassing screw machine 90. The second degassing device 89 may include a suction unit connected to the drainage opening 101 for suctioning the water vapour and/or the volatile components.

The housing 91 of the degassing screw machine 90 is connected to the housing 44 of the processing screw machine 4. The screw shafts 94, 95 extend into the second degassing opening 88.

In the discharge zone 72, the homogenised and degassed mixture 86 is discharged from the processing screw machine 4. For this purpose, the treatment element shafts 47, 48 comprise conveying elements 102, 102′ or screw elements in the discharge zone 72. The conveying elements 102, 102′ convey the mixture 86 through the discharge opening 65.

The treatment element shafts 47, 48 have a length L_{A} in the second conveying direction 63. Furthermore, the treatment element shafts 47, 48 have an external diameter D_{A} and an internal diameter d_{A}.

For the ratio of the length L_{A} to the external diameter D_{A}: 20≤L_{A}/D_{A}≤60, in particular 28≤L_{A}/D_{A}≤52 and in particular 36≤L_{A}/D_{A}≤40.

Furthermore, for the ratio of the external diameter D_{A} to the internal diameter d_{A}: 1.22≤D_{A}/d_{A}≤1.8, in particular 1.4≤D_{A}/d_{A}≤1.66 and in particular 1.5≤D_{A}/d_{A}≤1.6.

The processing facility 1 may comprise a melt pump and/or filter device and/or granulating device (not shown in greater detail) arranged downstream from the processing screw machine 4. The granulating device is for producing granulate from the discharged mixture 86.

The operation of the processing facility 1 is as follows:

The wet rubber 6 is fed through the feed hopper 21 and the feed opening 20 into the dewatering screw machine 2. The wet rubber 6 has a first water content W₁. The first water content Wi is at least 20% by weight, in particular at least 30% by weight, in particular at least 40% by weight and in particular at least 50% by weight.

The wet rubber 6 is for example a natural rubber and/or a synthetic rubber. Possibly, the wet rubber 6 is a synthetic rubber, for example acrylonitrile butadiene styrene (ABS).

In the intake zone 29, the wet rubber 6 is conveyed into the first dewatering zone 30. In the first dewatering zone 30, the wet rubber 6 is kneaded by the kneading elements 34, 34′, in such a way that water is squeezed out of the wet rubber 6. The retention elements 35, 35′, on the one hand, adjust the residence time of the wet rubber 6 in the region of the kneading elements 34, 34′ and, on the other hand, prevent water from flowing downstream in the first conveying direction 11. The squeezed-out water flows through the first dewatering opening 36 and the first filter insert 37 out of the housing 8 of the dewatering screw machine 2. The first filter insert 37 holds back the wet rubber 6.

The wet rubber 6 is pressed in the first conveying direction 11 into the second dewatering zone 31, where further dewatering takes place. The wet rubber 6 is kneaded by means of the kneading elements 38, 38′, and further water is squeezed out. The retention elements 39, 39′, on the one hand, adjust the residence time of the wet rubber 6 in the region of the kneading elements 38, 38′ and, on the other hand, prevent the squeezed-out water from flowing downstream in the first conveying direction 11. The squeezed-out water flows through the second dewatering opening 40 and the second filter insert 41, and is drained from the housing 8. The second filter insert 41 holds back the wet rubber 6.

The wet rubber 6 is thus successively dewatered in the dewatering zones 30, 31, in such a way that the dewatered rubber 7 is present in the discharge zone 32. The dewatered rubber 7 has a second water content W₂, which is lower than the first water content W₁. The second water content W₂ is at most 20% by weight, in particular at most 16% by weight, in particular at most 12% by weight, in particular at most 11% by weight, in particular at most 10% by weight, in particular at most 8% by weight, in particular at most 6% by weight, in particular at most 5% by weight and in particular at most 2% by weight.

For a relative change in water content ΔW=(W₁−W₂)/W₁, in particular 50%≤ΔW≤99%, in particular 60%≤ΔW≤95% and in particular 70%≤ΔW≤90%.

The dewatering screw machine 2 is operated at a rotational speed ne of the dewatering shafts 22, 23. For the rotational speed n_{E}: 40 rpm≤n_{E}≤600 rpm, in particular 50 rpm≤n_{E}≤400 rpm and in particular 60 rpm≤n_{E}≤300 rpm.

The dewatered rubber 7 is discharged through the discharge opening 19 and fed to the first feed device 3. The dewatered rubber 7 flows through the feed pipeline 43 from the discharge opening 19 to the first feed opening 73 of the processing screw machine 4. The dewatered rubber 7 is fed through the first feed opening 73 into the first intake zone 66 of the processing screw machine 4. When fed into the processing screw machine 4, the dewatered rubber 7 has a temperature T_{K}. For the temperature T_{K}: 60° C.≤T_{K}≤140° C., in particular 70° C.≤T_{K}≤130° C., in particular 85° C.≤T_{K}≤120° C. and in particular 100° C.≤T_{K}≤110° C.

The dewatered rubber 7 is conveyed by means of the conveying elements 74, 74′ in the second conveying direction 63 to the first degassing zone 67. The dewatered rubber 7 is kneaded by means of the kneading elements 75, 75′, in such a way that residual water escapes as water vapour and the second water content W₂ is further reduced. The escaping water vapour is drained from the housing 44 through the first degassing opening 76 by means of the first degassing device 77.

The SAN melt 78 is fed by means of the melt pump 83 and the feed pipeline 84 through the second feed opening 81 into the second intake zone 69 of the processing screw machine 4. At least one additive may be mixed into the SAN melt 78 before it is fed into the processing screw machine 4. The dewatered rubber 7 is thus fed into the processing screw machine 4 upstream from the SAN melt 78, in terms of the second conveying direction 63. A small part of the SAN melt 78 is conveyed by means of the retention elements 80, 80′, upstream in terms of the second conveying direction 63, into the retention zone 68, where the SAN melt 78 forms the melt seal 79 in the housing bores 45, 46. By means of the retention elements 80, 80′, on the one hand, the residence time of the dewatered rubber 7 in the first degassing zone 67 can be adjusted. On the other hand, further water vapour which arises in the second intake zone 69 and the melting zone 70 as a result of the contact of the dewatered rubber 7 with the hot SAN melt 78 cannot flow upstream, in terms of the second conveying direction 63, because the melt seal 79 formed in the retention zone 68 forms a barrier to the water vapour. As a result of the hot SAN melt 78, residual water can once again escape from the dewatered rubber 7. The water vapour which arises downstream from the retention zone 68 thus cannot flow into the first degassing zone 67 and potentially onwards into the first intake zone 66 and impair the feed of the dewatered rubber 7.

A temperature T_{S} of the hot SAN melt 78 is higher than the temperature T_{K} of the dewatered rubber 7. On the one hand, this leads to the evaporation of residual water from the dewatered rubber 7. On the other hand, the dissipated heat of evaporation reduces the temperature T_{S} of the SAN melt 78 and thus the temperature of the molten mixture 86, making the processing gentle. The lower temperature T_{K}, by comparison with the temperature T_{S}, on the one hand ensures evaporation of residual water, but on the other hand avoids adverse effects due to an excessively large temperature difference between the temperature T_{S} and the temperature T_{K}.

In the second intake zone 69, the dewatered rubber 7 and the SAN melt 78 are conveyed to the melting zone 70. In the melting zone 70, the dewatered rubber 7 is masticated and mixed in the SAN melt 78 by means of the kneading elements 85, 85′.

In the second degassing zone 71, the molten mixture 86 produced in the melting zone 70 is homogenised and degassed. Kneading by means of the kneading elements 87, 87′ causes additional water vapour and/or other volatile components to come out of the mixture 86. The water vapour and/or the other volatile components are drained from the housing 44 through the second degassing opening 88 by the second degassing device 89. The screw shafts 94, 95 rotate about the axes of rotation 96, 97 in such a way that the mixture 86 cannot escape from the housing bores 45, 46. In contrast, the water vapour and/or the other volatile components are sucked away by the suction unit through the second degassing opening 88, the housing bores 92, 93, and the drainage opening 101.

In the discharge zone 72, the homogenised and degassed mixture 86 is discharged from the processing screw machine 4 through the discharge opening 65. The discharged mixture 86 can then be granulated by means of a granulating device, and granulate can be produced.

The processing screw machine 4 is operated at a rotational speed n_{A} of the treatment element shafts 47, 48. For the rotational speed n_{A}: 40 rpm≤n_{A}≤1200 rpm, in particular 100 rpm≤n_{A}≤1000 rpm and in particular 200 rpm≤n_{A}≤800 rpm.

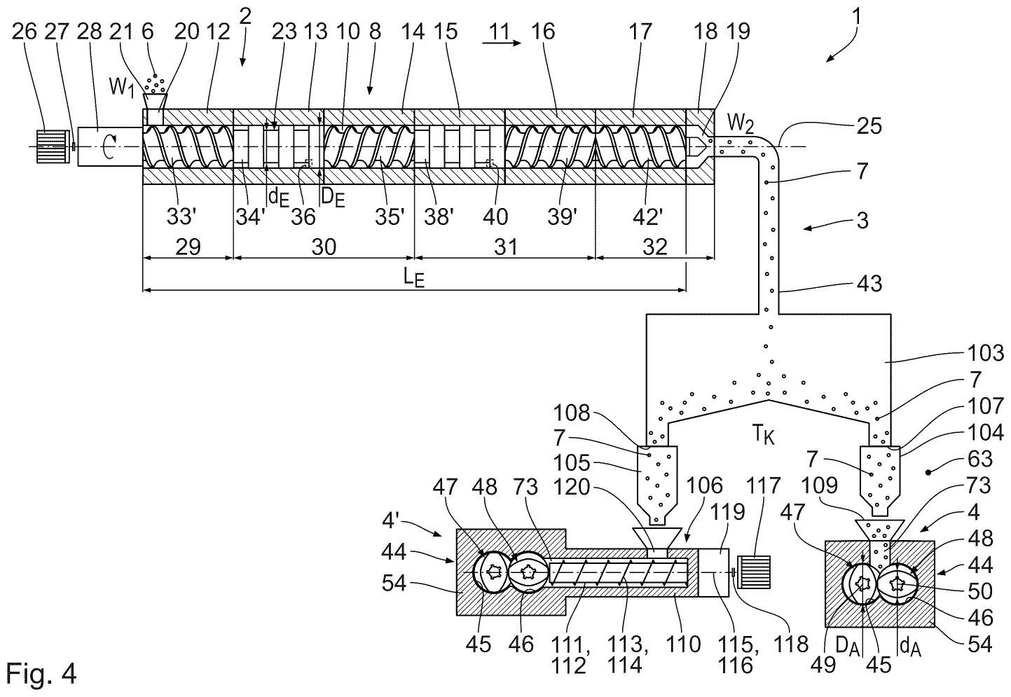

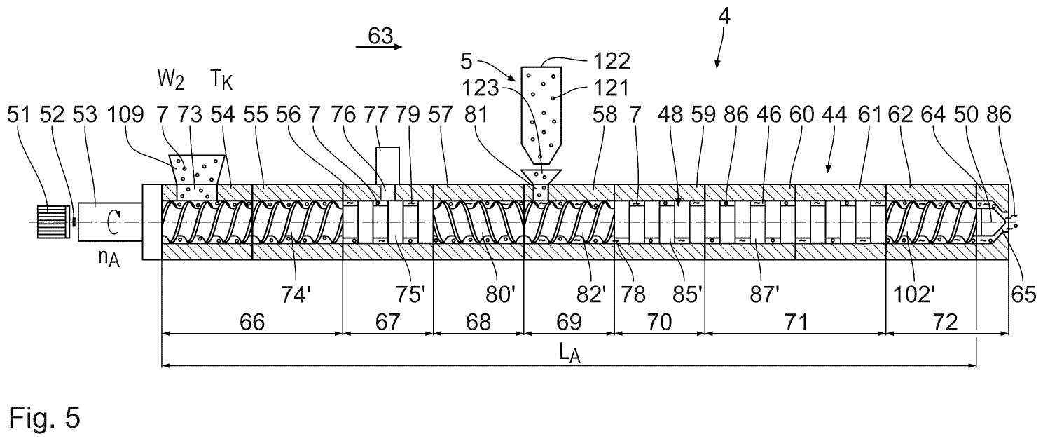

A second embodiment of the invention is described in the following with reference to FIGS. 4 and 5. By contrast with the first embodiment, the processing facility 1 comprises a first processing screw machine 4 and a second processing screw machine 4′, arranged mutually parallel.

Dewatered rubber 7 is provided to the processing screw machines 4, 4′ in the manner described above, by means of the dewatering screw machine 2.

By contrast with the first embodiment, the first feed device additionally comprises a buffer tank 103, a first metering device 104, a second metering device 105, a feed hopper 109 and a feed screw machine 106. The feed pipeline 43 connects the discharge opening 19 of the dewatering screw machine 2 to the buffer tank 103. The dewatered rubber 7 is temporarily stored and buffered in the buffer tank 103.

Starting from the buffer tank 103, a first feed option is described with reference to the first processing screw machine 4. The buffer tank 103 forms a first outlet opening 107. The first outlet opening 107 opens into the first metering device 104. The first metering device 104 is configured for example gravimetrically or volumetrically. The first metering device 104 meters the dewatered rubber 7 into the feed hopper 109 and thus feeds the dewatered rubber 7 into the first feed opening 73 of the processing screw machine 4. For this purpose, the feed hopper 109 is connected to the first processing screw machine 4 and opens into the first feed opening 73.

Starting from the buffer tank 103, a second feed option is described with reference to the second processing screw machine 4′. The buffer tank 103 forms a second outlet opening 108. The second outlet opening 108 opens into the second metering device 105. The second metering device 105 is configured gravimetrically or volumetrically. The second metering device 105 meters the dewatered rubber 7 into the feed screw machine 106. The feed screw machine 106 may be of a single-shaft or twin-shaft configuration. For example, the feed screw machine 106 is configured as a twin-shaft side-feed screw machine. The twin-shaft feed screw machine 106 is in particular configured co-rotating.

The feed screw machine 106 comprises a housing 110 in which two mutually parallel and interpenetrating housing bores 111, 112 are formed. The housing bores 111, 112 have a horizontal figure-of-eight shape in cross section. Two screw shafts 113, 114 are arranged in the housing bores 111, 112 and can be driven in rotation about associated axes of rotation 115, 116 in the same direction of rotation. For rotational drive, the feed screw machine 106 comprises an electric drive motor 117 and a branching gear 119, between which a coupling 118 is arranged. The screw shafts 113, 114 are driven in rotation about the axes of rotation 115, 116 in the same direction of rotation by the drive motor 117 via the branching gear 119.

The housing 110 is connected to the housing 44, in particular to the first housing portion 54 of the second processing screw machine 4′. The first feed opening 73 of the second processing screw machine 4′ is formed laterally. The screw shafts 113, 114 extend into the first feed opening 73. The second metering device 105 meters the dewatered rubber 7 into a feed opening 120 of the feed screw machine 106. The feed screw machine 106 conveys the dewatered rubber 7 by means of the screw shafts 113, 114 through the first feed opening 73 into the housing bores 45, 46 of the second processing screw machine 4′.

By contrast with the first embodiment, the styrene acrylonitrile is fed to the processing screw conveyors 4, 4′ as styrene acrylonitrile bulk material 121 (SAN bulk material). The SAN bulk material 121 is for example a SAN powder and/or a SAN granulate. At least one additive may be mixed into the SAN bulk material 121 before it is fed into the first processing screw conveyor 4 and/or the second processing screw conveyor 4′.

The second feed device 5 has a metering device 122 and a feed hopper 123 for each processing screw machine 4, 4′. Each metering device 122 is configured gravimetrically or volumetrically. Each metering device 122 opens into the associated feed hopper 123. Each feed hopper 123 is connected to the associated second feed opening 81. The SAN bulk material 121 is fed by means of the associated metering device 122 into the associated second feed opening 81 of the processing screw machines 4, 4′. To feed the SAN bulk material 121, a feed screw machine may be used as an alternative or in addition to each metering device 122. Each feed screw machine may be configured as a twin-shaft side-feed screw machine. Each twin-shaft feed screw machine may in particular be configured co-rotating. The SAN bulk material 121 and the dewatered rubber 7 are plasticised or masticated together in the associated melting zone 70 and mixed thoroughly. The temperature T_{K} of the dewatered rubber 7 can be used energy-efficiently for melting. The SAN bulk material 121 and/or the SAN melt 78 produced therefrom form a seal in the retention zone 68, in particular a melt seal 79.

For the further structure and operation of the processing facility 1, reference is made to the previous embodiment.

### In General:

If the processing facility has a plurality of processing screw machines, the plurality of processing screw machines may be identical and/or different in construction and/or be operated identically and/or differently. The plurality of processing screw machines can be used to increase capacity in the production of a mixture of the dewatered rubber and styrene acrylonitrile and/or to produce different mixtures of the dewatered rubber and styrene acrylonitrile.

1. A method for processing styrene acrylonitrile, comprising the following steps:
providing a processing facility with a dewatering screw machine and at least one processing screw machine,
feeding wet rubber having a first water content W₁ into the dewatering screw machine,
dewatering the wet rubber by means of the dewatering screw machine to form a dewatered rubber having a second water content W₂, where W₂<W₁,
discharging the dewatered rubber from the dewatering screw machine,
feeding the dewatered rubber and styrene acrylonitrile into the at least one processing screw machine,
producing a mixture of the dewatered rubber and styrene acrylonitrile by means of the at least one processing screw machine, and
degassing the produced mixture by means of the at least one processing screw machine.

2. The method recited in claim 1, wherein the first water content W₁ is at least 20% by weight.

3. The method recited in claim 1, wherein second water content W₂ is at most 20% by weight.

4. The method recited in claim 1, wherein the dewatered rubber has a temperature T_{K} when fed into the at least one processing screw machine, where: 60° C.≤T_{K}≤140° C.

5. The method recited in claim 1, wherein the dewatered rubber is fed in a conveying direction upstream from the styrene acrylonitrile into the at least one processing screw machine.

6. The method recited in claim 1, wherein the styrene acrylonitrile is fed as a bulk material into the at least one processing screw machine and melted by means of the at least one processing screw machine to form a styrene acrylonitrile melt, or the styrene acrylonitrile is fed as a styrene acrylonitrile melt into the at least one processing screw machine.

7. The method recited in claim 1, wherein a seal is formed in the at least one processing screw machine between a first feed point of the dewatered rubber and a second feed point of the styrene acrylonitrile.

8. A processing facility for processing styrene acrylonitrile, comprising:
at least one processing screw machine for processing dewatered rubber and styrene acrylonitrile;
a dewatering screw machine for dewatering wet rubber and for providing the dewatered rubber, and
a feeding device for feeding the dewatered rubber into the at least one processing screw machine.

9. The processing facility recited in claim 8, wherein the dewatering screw machine comprises at least one dewatering shaft having a length L_{E} and an external diameter D_{E}, where: 16≤L_{E}/D_{E}≤40.

10. The processing facility recited in claim 8, wherein the dewatering screw machine comprises at least one dewatering shaft having an external diameter D_{E} and an internal diameter d_{E}, where: 1.22≤D_{E}/d_{E}≤1.8.

11. The processing facility recited in claim 8, wherein the dewatering screw machine comprises at least one dewatering zone.

12. The processing facility recited in claim 8, wherein the feed device comprises at least one feed pipeline, at least one feed hopper, a buffer tank, at least one metering device, or at least one feed screw machine.

13. The processing facility recited in claim 8, wherein each of the at least one processing screw machine comprises at least two treatment element shafts having a length L_{A} and an external diameter D_{A}, where:
$$20 \leq {L}_{A} / {D}_{A} \leq 60 .$$

14. The processing facility recited in claim 8, wherein each of the at least one processing screw machine comprises at least two treatment element shafts having an external diameter D_{A} and an internal diameter d_{A}, where: 1.22≤D_{A}/d_{A}≤1.8.

15. The processing facility recited in claim 8, wherein each of the at least one processing screw machines comprises a first feed opening for feeding the dewatered rubber and a second feed opening for feeding the styrene acrylonitrile, the first feed opening being arranged upstream from the second feed opening in a conveying direction.

16. The processing facility recited in claim 15, wherein each of the at least one processing screw machines comprises at least one retention zone, arranged between the first feed opening and the second feed opening, for forming a seal.

17. The processing facility recited in claim 15, wherein each of the at least one processing screw machines comprises at least one first degassing zone, arranged between the first feed opening and the second feed opening.

18. The processing facility recited in claim 15, wherein each of the at least one processing screw machines comprises at least one second degassing zone, arranged downstream from the second feed opening in the conveying direction.
